(19) United States
(12) Patent Application Publication
(10) Pub. No.: US 2025/0187692 A1
(43) Pub. Date: Jun. 12, 2025

(54) THERMAL CONTROL MODULE FOR A SYSTEM FOR THERMALLY CONTROLLING ALL OR A PORTION OF A PERSON'S BODY, AND SYSTEM AND MOTORCYCLE COMPRISING SUCH A MODULE

(71) Applicant: SD & BA, Toulouse (FR)

(72) Inventor: David STAS, Toulouse (FR)

(21) Appl. No.: 18/846,382

(22) PCT Filed: Mar. 13, 2023
(86) PCT No.: PCT/EP2023/056383

§ 371 Date: Sep. 12, 2024

(30) Foreign Application Priority Data
Mar. 15, 2022 (FR) FR2202274

(51) Int. Cl. B62J 33/00; A41D 13/005; A41D 13/018; F25B 21/04

(52) U.S. Cl. CPC B62J 33/00; A41D 13/005; A41D 13/018; F25B 21/04; A41D 2600/102

(57) ABSTRACT

A thermal control module for a system for thermally controlling all or a portion of a person's body including a housing with a lower face having a plurality of anchor points on a bracket for mounting a luggage item for a motorcycle, and an upper face having a plurality of points for mounting a luggage item for a motorcycle, the lower and upper faces being separated by a height, the housing has a location for mounting a heat exchange element having a means for distancing the heat exchange element from the walls of the housing, and a face for exchanging heat with the area surrounding a Peltier device thermally connected to a heat-pipe radiator extending in a direction orthogonal to the height, where the height is minimised and the exchange of heat with the surrounding area is maximised.

### CROSS-REFERENCE TO RELATED APPLICATIONS

This Application is a National Stage of International Application No. PCT/EP2023/056383, having an international filing date of 13 Mar. 2023, which designated the United States of America, and which International application was published under PCT Article 21(2) as WO Publication No. 2023/174889, which claims priority from and the benefit of French Patent Application No. 2202274 filed on 15 Mar. 2022, the disclosures of which are incorporated herein by reference in their entireties.

### BACKGROUND

### Field

The field of the present disclosure is that of thermal control of all or a portion of a person's body.

More specifically, the present disclosure relates to a thermal control module for a system for thermally controlling all or a portion of a person's, in particular a motorcyclist's, body. The module is adapted to cooperate with an item of thermal control clothing. The present disclosure also relates to a system comprising such a module, coupled with an item of thermal control clothing. The present disclosure furthermore relates to a motorcycle equipped with such a system.

The present disclosure particularly finds applications in thermal control of all or a portion of a person's body. In particular, the torso and/or the lower limbs of the person's body are thermally controlled. The thermal control may correspond to a supply of heat to the person's body, i.e. it is intended to warm it up, just like it may correspond to a removal of heat from the person's body, i.e. it is intended to cool it down. The thermal control system according to the present disclosure is therefore reversible.

### Brief Description of Related Developments

Thermal control techniques, in particular for a person's body, are known from the prior art. For example, certain techniques involve thermal control clothing, such as jackets or trousers, wherein a heat transfer fluid can circulate. The fluid, which is generally a liquid, is cooled or heated in a module external to the item of clothing.

Such a module requires a source of energy, in particular electrical, in order to transfer energy and remove, or supply, calories from the heat transfer fluid to the surrounding area, or from the surrounding area to the heat transfer fluid.

A known technique consists of using Peltier-effect thermoelectric devices, or modules. A Peltier device is a semiconductor structure composed of a succession of P-N junctions (i.e. positively, respectively negatively doped semiconductors). When a direct electric current passes through it, such a structure has the specificity of producing heat when the current flows from a P semiconductor to an N semiconductor (i.e. the junction acts as a heat source), and of capturing heat when the current flows from an N semiconductor to a P semiconductor (i.e. the junction acts as a heat sink). With a grouped arrangement of P to N and N to P junctions, it is possible to obtain a device having two faces, of which one can be heated, and the other cooled, when an electric current passes through the device. By inverting the direction of the direct electric current, the device is rendered reversible.

In the context of a module of a thermal control system by transporting heat in a heat transfer fluid, one of the faces of the Peltier device is thermally connected to the heat transfer fluid, in order to transport heat to the person.

A hydraulic circuit adapted for such transport is also part of such a thermal control system.

The source of electrical energy supplying the Peltier device is generally an electric battery, in particular when the system is mobile. For example, mobile systems for thermally controlling a motorcyclist's body are known. The source of electrical energy is then generally the motorcycle battery.

Document US 2009/308082 A1 which describes a technique for heating a motorcyclist's body by means of the following steps is for example known: transferring heat from the atmosphere to a thermally conductive element mounted on a motorcycle via the Peltier effect; and circulating a working liquid in a closed circuit from the thermally conductive element, through an item of clothing worn by the motorcyclist via an inlet coupling and an outlet coupling, then back to the thermally conductive element. In another configuration, the operation is reversed to cool the motorcyclist's body.

Although prior art systems are satisfactory in terms of thermal control performances, their integration in vehicles such as motorcycles remains relatively unsatisfactory.

Indeed, firstly, prior art techniques require an adaptation to each motorcycle type or model, according to the space available, and technical constraints governed by each motorcycle.

Thus, although a satisfactory integration solution may be found for each particular motorcycle type or model, this approach implies high design and production costs, logistic, maintenance, and after-sales service problems, and does not satisfy all motorcycle users' needs.

Therefore, there is a need for a single thermal control system which is compatible with a large number of motorcycles.

Secondly, prior art techniques are not readily removable or replaceable. Indeed, some proposed solutions involve replacing original parts of the vehicle with modified parts comprising the components of the thermal control system.

Such a solution has drawbacks in terms of approval of the replacement parts, and it also has drawbacks for the user who must keep the original part to fit it in place of the control system when they wish to remove it, for example when they temporarily no longer wish to use it, or when they wish to sell their vehicle.

Therefore, there is a need for a thermal control system which can be integrated on a motorcycle without requiring modification of the motorcycle, or replacement of any of its parts.

Thirdly, prior art techniques are not fully satisfactory in their size/heat evacuation ratio. Indeed, current systems are either relatively bulky, in order to have sufficient thermal dissipation surface areas and thermal flow channels. When it is undertaken to reduce the size, current systems are no longer as effective in terms of heat evacuation, in particular in extreme temperature ranges (i.e. substantial cooling in a hot environment, like in summer, or conversely substantial heating in a cold environment, like in winter).

Therefore, there is the need for a thermal control system which is both effective in terms of thermal dissipation and compact.

None of the current systems makes it possible to simultaneously meet all the required needs, namely providing a technique for a thermal control system which is compatible with a large number of motorcycles, without requiring modification of the motorcycle, and which is compact but effective in terms of thermal dissipation.

### SUMMARY

The present present disclosure aims to overcome all or some of the above-mentioned drawbacks of the prior art.

To this end, the present disclosure relates to a thermal control module for a system for thermally controlling all or a portion of a person's, in particular a motorcyclist's, body, including an open fluidic circuit comprising:
a compensation reservoir adapted to contain a volume of heat transfer fluid,
a pump adapted to circulate said heat transfer fluid in said open fluidic circuit,
a heat exchange element adapted for the circulation of said heat transfer fluid, said heat exchange element being thermally connected to a first heat exchange face of a Peltier-effect thermoelectric device adapted to be electrically connected to a direct current source, the thermoelectric device having a second heat exchange face with the surrounding area,
   said reservoir, said pump and said heat exchange element being fluidically connected and being disposed in the body of a housing, and said open fluidic circuit having an inlet opening and an outlet opening evacuating respectively from said housing, the inlet and outlet openings being adapted to be connected, directly or indirectly via a flexible conduit, respectively to an end of a conduit of an item of thermal control clothing so as to form a closed fluidic circuit,
said housing comprises a lower face having a plurality of anchor points on a structural element of a motorcycle, in particular on a bracket for mounting a “top-case” or saddlebag type luggage item for a motorcycle, and an upper face having a plurality of points for mounting a “top-case” or saddlebag type luggage item for a motorcycle, said lower and upper faces being separated by a height h,
said housing has a location for mounting the heat exchange element having a means for distancing the heat exchange element from the walls of the housing,
said heat exchange face with the surrounding area is thermally connected to at least one “heat-pipe” type radiator extending in a direction orthogonal to the height h.

Thanks to these arrangements, the height h is minimised and the exchange of heat with the surrounding area is maximised.

Indeed, the housing as proposed by the present disclosure allows a “sandwiched” or gripped mounting between a motorcycle structure, and a luggage item for a motorcycle, in a completely innovative manner compared to the known prior art.

The housing is designed, on its upper and lower faces, so as to be able to make use of a conventional system for mounting a luggage item on a motorcycle. This results in a particularly flexible system, which is integrated simply and without substantial modifications on a motorcycle.

The height h of the housing must be as small as possible, so that the module according to the present disclosure is as compact as possible, so as not to hinder the use of the luggage item, and preserve the aesthetic appearance of the motorcycle.

The arrangement of the heat exchange elements away from the walls of the housing makes it possible to improve heat exchanges in a housing of reduced size. Connecting the thermoelectric device with a perpendicularly oriented heat-pipe radiator makes it possible to maximise heat exchanges in a reduced space, by the particular choice of the orientation and type of radiator.

These arrangements make it possible to obtain very efficient and effective thermal control even in extreme temperature ranges, while working towards reducing the height of the housing. It would not have been possible to expect such a result in the light of the solutions proposed in the prior art, for which reducing the size of a thermal control module always means a decrease in thermal control performance.

According to a preferential aspect, the anchor points are presented on a lower plate mounted removably on the housing body.

In this way, the module is even more adaptable, in a very simple way, simply to specific or manufacturers' proprietary anchor systems. It is simply necessary to change the lower plate to adapt to a new anchor system.

According to a preferential aspect, the mounting points are presented on an upper plate mounted removably on the housing body.

In this way, the module is even more adaptable, in a very simple way, to specific or manufacturers' proprietary anchoring systems. It is simply necessary to change the upper plate to adapt to a new luggage item. Generally, the upper and lower plates correspond to the same luggage item coupling system, and are designed by corresponding pairs.

According to a preferential aspect, the anchor points are disposed according to an anchoring pattern reproduced at at least two separate positions, so as to allow the mounting in at least two mounting positions of the housing on said structural element.

In this way, it is possible to adjust the position of the module, and indirectly of the luggage item, by choosing either of the anchoring patterns. Generally. a second pattern is obtained by moving the first pattern in translation along a longitudinal direction of the module, corresponding to the direction of advance of the motorcycle when the module is mounted on the motorcycle.

According to a preferential motorcycle, said distancing means is formed by a plurality of blocks moulded on a lower wall of the housing body, the blocks being adapted to support said heat exchange element.

In this way, the distancing means and a portion of the housing are provided in a single part, which reduces the steps of manufacture and assembly. Furthermore, there is no risk of movement of the distancing means. The blocks are advantageously particularly flat relative to the height of the heat exchange element, and preferably have a height less than 1 millimetre. In this aspect, it is particularly advantageous that the housing body be made of moulded plastic.

According to an alternative aspect, said distancing means is a layer of insulating material disposed against a lower wall of the housing body.

This aspect has the advantage of simpler manufacture of the housing body, and of being able to select an insulating material with particular properties. The layer of insulating material may for example be an insulating foam.

According to a preferential aspect, the location for mounting the heat exchange element is substantially centred on a lower wall of the housing body, and wherein said radiator extends at least on either side of said location, substantially to the lateral walls of said housing body

Through these arrangements, the heat exchange element is disposed centrally. The thermoelectric device is disposed on the heat exchange element, on which the radiator is disposed. The thermoelectric device is thus also located at the centre of the lower wall of the housing, and the radiator can extend on either side so as to optimise its operation. The radiator preferably also extends above the thermoelectric device, to which it is thermally connected, and therefore above said location. Indeed, the ends of the heat-pipes are located at a maximum distance from the thermoelectric device, while maximising the heat exchange surface area.

According to a preferential aspect, said reservoir is directly integrated in the lower wall of said housing body.

Thus, it is possible to do without a reservoir wall, and significantly reduce the height h further. It is also possible to mould all or a portion of the reservoir directly with the housing body, thus reducing the steps of manufacture and assembly further.

According to a preferential aspect, the housing body comprises a magnetised zone on one of its lateral walls.

In this way, it is possible to hold, for storage purposes, a flexible conduit end protruding from the module in position. The end of the conduit is then also magnetised, or metallic.

According to a preferential aspect, the housing comprises a hatch on one of its lateral walls, accessible from the exterior of the housing, opening onto a cavity adapted to contain a flexible conduit for connecting to an item of thermal control clothing in a storage position.

Thus, the storage of the flexible conduit for connecting the module to the clothing is enhanced. The risk of damage of the conduit is reduced, and the aesthetic appearance of the module is preserved.

According to a preferential aspect, the housing comprises an automatic reel, preferably with a spring, of a flexible conduit for connecting to an item of thermal control clothing, and a means for locking said flexible conduit in a variable unwound position.

Thanks to these arrangements, the storage of the flexible conduit is facilitated further, the reel making it possible to store the conduit automatically when it is disconnected from the item of clothing. Furthermore, an adapted conduit length may be selected thanks to the locking means, making it possible to prevent the conduit hindering the user with an unsuitable length.

According to a preferential aspect, the module also comprises a control unit connected to said thermoelectric device and to said pump, and configured at least to switch said module on and off, and control an operating temperature or control a power consumption by the thermoelectric device.

Thus, the user may choose different module operating levels, adapted to the circumstances.

According to a preferential aspect, the control unit comprises a means for wireless communication with a remote control of said module, said remote control being configured at least to switch said module on and off, and set a set-point temperature of the person's body or control a power consumption level by the thermoelectric device.

In this way, the user may comfortably control the operating level while driving the motorcycle in particular, for example when the remote control is mounted on the steering wheel of the motorcycle.

According to a preferential aspect, the control unit is configured to
detect a background noise of the electronic signal from the direct current source, wherein the direct current source is a battery external to said module, in particular a motorcycle battery;
   and when no background noise is detected;
switching the module off.

Thus, the module may be prevented from being switched on while the motorcycle engine, which powers the module via its battery, is not switched on. This makes it possible to avoid draining the motorcycle battery, which would prevent the user from restarting their vehicle.

The present disclosure also relates to a system for thermally controlling all or a portion of a person's, in particular a motorcyclist's, body, comprising a thermal control module according to the present disclosure, and an item of thermal control clothing, the inlet and outlet options of said module being connected, directly or indirectly via a flexible conduit, respectively to an end of a conduit of the item of thermal control clothing.

According to a preferential aspect, the item of thermal control clothing includes a double skin closed by stitching at the periphery of the item of clothing, and wherein the conduit of the thermal control clothing is bonded to the inner skin of the double skin, so as to be located inside the double skin.

Thus, a very visually appealing finish may be obtained, since the conduit of the control clothing is no longer visible directly outside the clothing. Furthermore, this manufacturing mode is also much simpler, because it is simply necessary to reclose the double skin and no longer bond the two skins to each other, as was done in the prior art.

According to a preferential aspect, the item of thermal control clothing is also an item of safety clothing and includes an airbag, the conduit of the item of thermal control clothing being welded, preferably by high-frequency welding, on an inner face of said airbag.

Thus, a particularly advantageous user safety function is obtained. Contrary to what the prior art suggested, it appears that the coexistence of a thermal control and safety function is possible, without hindering the operation of either of the functions, and without increasing the total size of the item of clothing.

The present disclosure also relates to an assembly comprising a motorcycle and a system for thermally controlling all or a portion of a person's, in particular a motorcyclist's, body according to the present disclosure, and wherein said module is electrically connected to a motorcycle battery, and mechanically connected to a structural element of the motorcycle, in particular to a bracket for mounting a “top-case” or saddlebag type luggage item for a motorcycle, via said plurality of anchor points on a structural element of a motorcycle.

According to a preferential aspect, the assembly furthermore comprises a “top-case” or saddlebag type luggage item for a motorcycle mounted on said module via said plurality of points for mounting a “top-case” or saddlebag type luggage item for a motorcycle, such that said housing is “sandwiched” between said structural element of the motorcycle and said luggage item for a motorcycle.

### BRIEF DESCRIPTION OF THE FIGURES

Other particular advantages, aims and features of the present present disclosure will become apparent from the following non-limiting description of at least one particular aspect of the devices and methods objects of the present present disclosure, with reference to the appended drawings, wherein:

FIG. 1 is a schematic representation of the operation of a thermal control system,

FIG. 2 is a schematic perspective representation of the module,

FIG. 3 is a schematic representation of a side view of the module,

FIG. 4 is a schematic representation according to two views of a motorcycle equipped with a module,

FIG. 5 is a schematic representation of a motorcycle equipped with a module, on which a luggage item is mounted,

FIG. 6 is a bottom view of the module, wherein the lower face of the housing appears,

FIG. 7 is a top view of the module, wherein the upper face of the housing appears,

FIG. 8 is a schematic partial perspective representation of the open module,

FIG. 9 is a detailed sectional view of the reservoir of the module according to a particular aspect,

FIG. 10 is a schematic perspective representation of the flat bottom of the module, and

FIG. 11 is a schematic partial perspective representation of the module, wherein a heat-pipe radiator particularly appears.

### DETAILED DESCRIPTION

The present description is given as a non-limiting example, each feature of one aspect could be advantageously combined with any other feature of any other aspect.

As of now, it should be noted that the figures are not plotted to scale.

### Example of a Particular Aspect

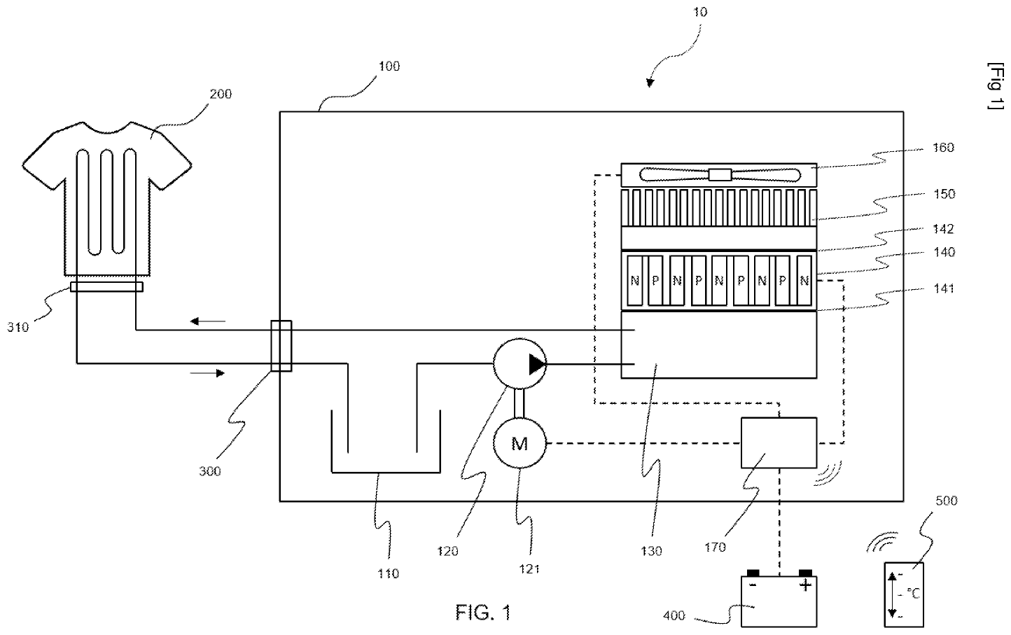

FIG. 1 schematically represents the operation and the structure of a thermal control system 10.

A thermal control module 100 comprises an open fluidic circuit. The fluid circulating in the circuit is a heat transfer fluid. In particular, the fluid is a liquid, such as water for example.

The fluidic circuit starts, in the direction of circulation of the fluid, with an inlet opening of a conduit, leading to a reservoir 110 disposed inside the module 100. The reservoir 110 is a compensation reservoir adapted to contain a volume of heat transfer fluid. The reservoir 110 serves to compensate the differences in volume of the heat transfer fluid, capable of occurring during the use of the thermal control system, primarily on account of temperature variations.

An outlet conduit of the reservoir 110 connects the latter to a pump 120. The pump 120 is adapted to circulate the heat transfer fluid in the open fluidic circuit, but also in the closed fluidic circuit as described hereinafter. The pump 120 is preferably actuated by an electric motor 121.

According to a preferential variant, the pump 120 is directly disposed in the enclosure of the reservoir 110. A particularly compact arrangement may thus be obtained. Furthermore, the risks of leaks are reduced by reducing the number of conduits and connectors.

An outlet conduit of the pump 120 connects the latter to an inlet opening of a heat exchange element 130. The heat exchange element 130 is a compartment wherein the heat transfer fluid can circulate. The heat exchange element 130 is in particular substantially parallelepipedal rectangular, of low height. It is advantageous that the heat exchange element 130 has at least one face of significantly greater size than the sizes of the other faces, in particular the lateral faces, in order to have the greatest possible heat exchange surface area.

Such a heat exchange element 130 is sometimes referred to as a water block, in the case of an element capable of containing water as heat transfer fluid.

An outlet conduit of the heat exchange element 130 extends to open from the module 100, and forms at this position an outlet opening of the open fluidic circuit.

The open fluidic circuit thus has an inlet opening and an outlet opening, which may be connected to an inlet opening and an outlet opening of an item of thermal control clothing 200, or temperature regulating clothing. In particular, the opening and the outlet of the open fluidic circuit may protrude slightly from the module 100, and take the form of flexible tubes at the end of which couplings may be disposed, as described hereinafter.

At least one conduit for circulating the heat transfer fluid travels through the item of clothing 200. The conduit has an inlet opening and an outlet opening, which can be connected respectively to the outlet opening and the inlet opening of the module 100. The open fluidic circuit of the module 100 and the conduit of the item of clothing 200, which represents another open fluidic circuit, then form a closed fluidic circuit. The heat transfer fluid may circulate in the closed fluidic circuit, and heat or cool the wearer of the item of clothing 200.

The connection of the module 100 to the item of clothing 200 is preferably carried out by means of a coupling 300. The coupling 300 is produced so as to form a valve opening when the connection between an inlet opening and an outlet opening is performed, and which remains closed when the module 100 and the item of clothing 200 are separated. Thus, the heat transfer fluid contained in the module 100 and the item of clothing 200 cannot flow when the fluidic circuits are open. Preferably, the coupling 300 is also produced so as to uncouple the module 100 from the item of clothing 200 when a tension greater than a predefined threshold is exerted on the coupling, for example in the case of a fall or uncoupling oversight. The coupling 300 may be produced so as to group the inlet and the fluidic outlet of the module 100, or be presented in the form of an inlet coupling and a separate outlet coupling.

Alternatively or in addition to the coupling 300, it is also possible to provide a coupling 310 near the item of clothing 200. The coupling 310 may in particular be similar to the coupling 300 in its design. When two couplings 300 and 310 are used, the connection between the module 100 and the item of clothing 200 is performed indirectly by means of a connection or linking conduit, for example a flexible conduit.

The module 100 includes moreover a Peltier-effect thermoelectric device 140, or Peltier device 140. The thermoelectric device 140 is adapted to be electrically connected to a direct current source, for its electrical power supply.

As described in the description of the prior art, a Peltier device is a semiconductor structure composed of a succession of P-N junctions, which are disposed such that the device has one face which can be heated, and another face which can be cooled, when an electric current passes through the device in a first direction, and conversely, when an electric current passes through the device in a second direction.

The thermoelectric device 140 has a first heat exchange face 141. The first face 141 is thermally connected to the heat exchange element 130. The thermal connection may be carried out by mere contact, optionally supplemented by applying a thermal paste making it possible to improve the thermal conduction.

The thermoelectric device 140 has a second heat exchange face 142. The second face 142 is a heat exchange face with the surrounding area. In particular, the second face 142 has the role of heat dissipation, when the module 100 is used for cooling.

In order to improve the heat dissipation, the second face 142 is thermally connected to a radiator 150. Here also, applying a thermal paste may be envisaged.

In order to improve heat evacuation, one or more fans 160 may be provided in the vicinity of the radiator 150, so as to transport the heat by convection outside the module 100.

The power supply of the module 100 is preferably provided by one or more external electric batteries. For example, one or more external batteries may be comprised in a motorcycle battery 400. It is however possible to envisage the use of other types of external batteries, in particular a dedicated battery. Such a dedicate battery may however also be internal to the module 100.

Advantageously, the battery 400 also provides the electrical power supply of other components of the module 100, such as the motor 121 of the pump 120, one or more fans 160, or a control unit 170 of the module 100.

The control unit 170 is electrically connected to the motor 121 and to the thermoelectric device 140, and to the fans 160 when the module 100 is equipped with it. In particular, it is also electrically connected to the battery 400, so as to distribute the energy to the different components of the module 100. In FIG. 1, the electrical connections are represented schematically as dotted lines.

The control unit comprises in particular a computer or processor

The control unit 170 is configured at least to switch the module 100 on and off, and control an operating temperature. To control the set-point temperature, the control unit 170 may compare a set-point temperature of the person's body with a measured temperature. The measured temperature may be measured either on the fluidic circuit of the module 100, or on the item of clothing 200. According to the result of the comparison, the operating temperature is increased or lowered.

The control unit 170 may also be configured at least to switch the module 100 on and off, and control a level of electric power of the thermoelectric device 140. More specifically, it is provided that several heating levels and several cooling levels are selectable, for example via a human-machine interface such as a remote control. Each level corresponds to a power consumption value of the thermoelectric device 140. The equivalences between these levels and the power values may be indexed in a table stored in a non-volatile storage memory of the control unit 170.

The control unit 170 may furthermore be equipped with a wireless communication means with a remote control 500 of the module 100. The remote control 500 is configured at least to switch the module 100 on and off, and set a set-point temperature of the person's body, or control a power consumption level of the thermoelectric device 140. The remote control 500 may be equipped with means for mounting on motorcycle handlebars, for example via a magnetic connection with a bracket mounted on the handlebars. Preferably, the wireless data link established between the remote control 500 and the module 100 is established according to a Bluetooth (registered trademark) protocol or by radiofrequencies. It may also be envisaged to establish a wired data connection between the control unit 170 and the remote control 500, which may then be offset to a fixed location such as the motorcycle handlebars.

The module 100 comprises a housing 180 comprising a body wherein the aforementioned components of the module 100 are disposed. The body of the housing 180 forms a closed cavity containing the essential components of the module 100, such as the reservoir 110, the pump 120 and the heat exchange element 130 in particular.

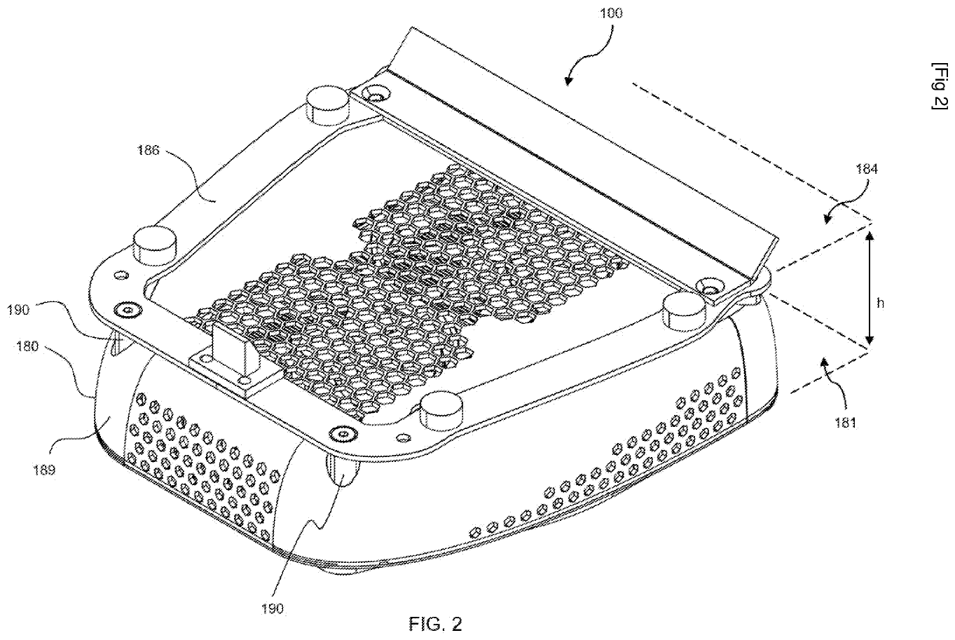

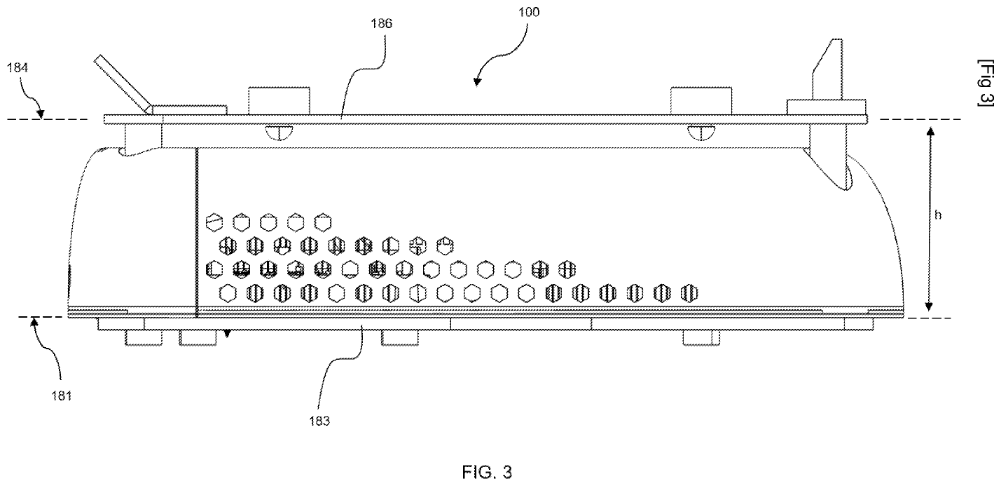

FIGS. 2 and 3 represent the exterior of the module 100, in a perspective and side view. The module 100 according to the present disclosure has the specificity of being integrable on a structural element of a motorcycle, and in particular on a bracket for mounting a “top-case” or saddlebag type luggage item for a motorcycle. Furthermore, the module 100 according to the present disclosure also has the specificity of allowing the mounting of a “top-case” or saddlebag type luggage item for a motorcycle on the housing 180. In this way, the module 100 is integrated on a motorcycle without requiring modification of the motorcycle, using otherwise existing anchor points of the motorcycle, while making it possible to continue mounting the luggage items on the motorcycle.

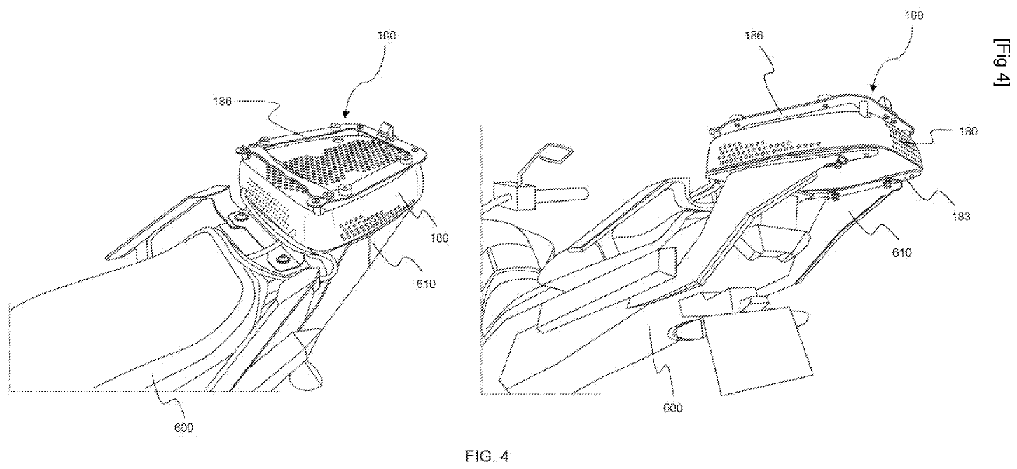

FIG. 4 represents a motorcycle 600 equipped with a module 100 according to the present disclosure, mounted on a bracket 610 for mounting a luggage item of the motorcycle.

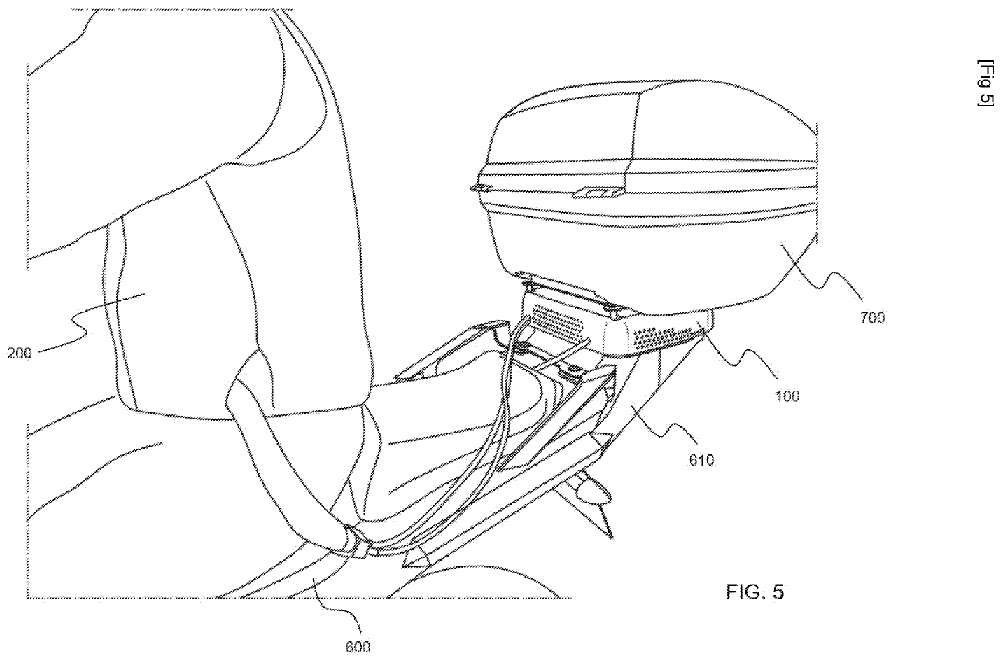

In FIG. 5, a luggage item 700 mounted on the module 100 has additionally been represented. As represented, the particular design of the module 100 allows particularly discreet integration on the motorcycle 600. It can be seen that the module 100 is “sandwiched”, or gripped, between the structural element of the motorcycle and the luggage item 700.

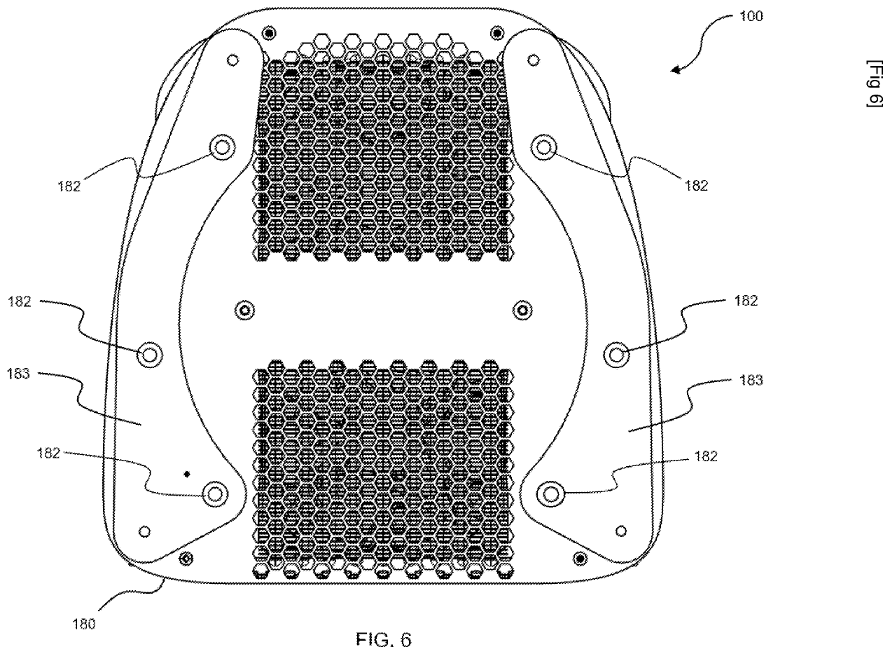

As represented in FIG. 6, in order to carry out the mounting on the motorcycle, the housing 180 includes on a lower face 181 a plurality of anchor points 182 on a structural element of the motorcycle 600. The anchor points 182 may in particular be threaded openings, intended to receive mounting screws. The structural element of the motorcycle is in particular a bracket for mounting a luggage item for a motorcycle. The mounting brackets may be pre-existing on the motorcycle, or added.

In order to remedy the problem of proprietary motorcycle luggage manufacturer mounting brackets, having a particular type of anchor point, the anchor points 182 are presented on a lower plate 183 removably mounted on the body of the housing 180. The removable mounting is performed in particular via a universal mounting point pattern, making it possible to adapt any plate to the housing 180. Mounting may be performed in particular by screwing. The lower face 181 then corresponds to the plane wherein the lower plate 183, which is part of the housing 180 is disposed. In this way, it is only necessary to adapt the lower plate 183 to the proprietary mounting bracket, but not to the rest of the housing 180.

In particular, the lower plate 183 may be made of two parts, as represented in FIG. 6. The lower plate 183 takes for example the form of two mounting wings each including three anchor points 182.

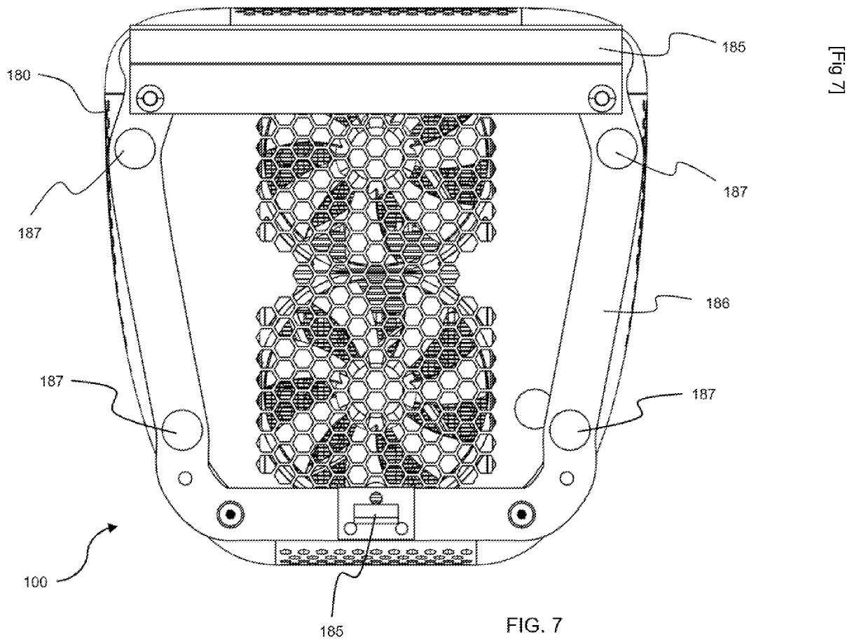

Similarly, as represented in FIG. 7, in order to mount a luggage item 700 on the housing 180, the housing 180 includes on an upper face 184 a plurality of points 185 for mounting a luggage item 700. The mounting points 185 may in particular be formed by a holding rail and a locking pin disposed at opposite edges of the upper face 184. Such a type of mounting is in particular known from “top-case” type luggage items from the manufacturer Givi (registered trademark).

In order to remedy the problem of proprietary motorcycle luggage manufacturer mounting systems, having a particular type of mounting point, the mounting points 185 are presented on an upper plate 186 removably mounted on the body of the housing 180. The upper face 184 then corresponds to the plane wherein the upper plate 186, which is part of the housing 180 is disposed. In this way, it is only necessary to adapt the upper plate 186 to the proprietary luggage item, but not to the rest of the housing 180.

According to a preferential variant, the upper plate 186 remains unchanged for all types of luggage items, and only the mounting points 185 are adapted to the luggage item. In other words, the mounting points 185 may themselves be removable on the upper plate 186. This solution has the advantage of greater flexibility, however it is slightly bulkier than the aforementioned solution directly integrating the mounting points 185 to the upper plate 186.

For example, the upper plate 186 adopts a substantially rectangular ring shape, of substantially equal size to the upper face 184. Support blocks 187 of the luggage item 700 may be provided on the upper plate 186.

Preferably, it is planned to provide a user with a set of lower 183 and upper 186 plates, since a particular type of mounting bracket will generally be used with a compatible luggage item 700.

According to an advantageous variant, the anchor points 182 are disposed according to an anchoring pattern reproduced at at least two separate positions, so as to allow the mounting in at least two mounting positions of the housing 180 on the structural element. More specifically, a set of anchor points 182 disposed according to a particular pattern, corresponding to a particular type of motorcycle luggage anchor system, is reproduced in a slightly different position. In particular, the pattern is reproduced at least once by translation along the axis of symmetry of the housing 180, corresponding substantially to the axis of advance of the motorcycle. In this way, it is possible to adjust the longitudinal position of the housing 180 on the motorcycle, by selecting the group of suitable anchor points.

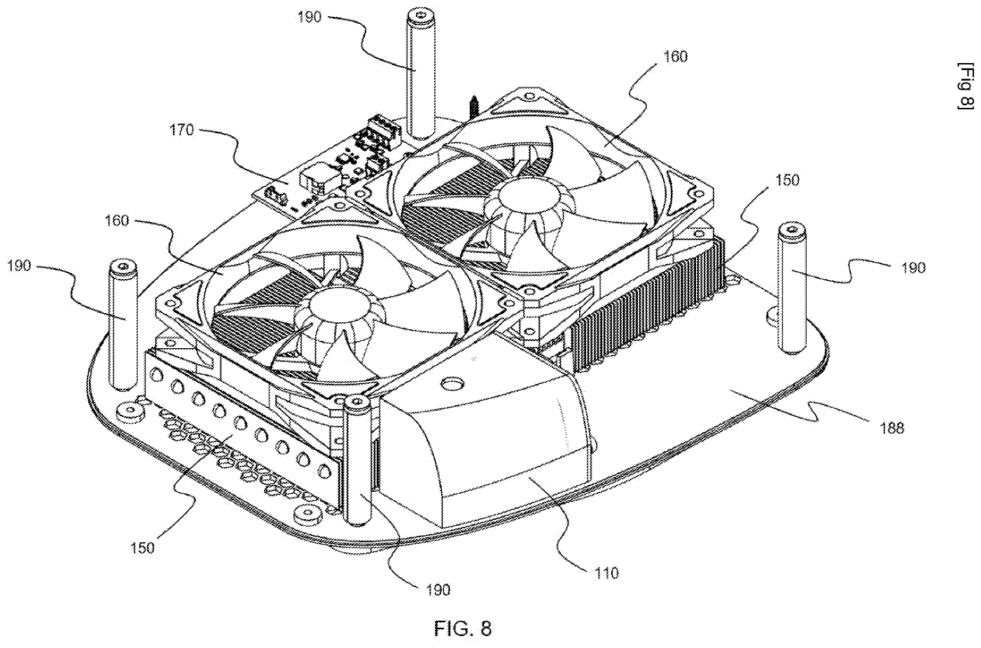

According to a preferential variant, as seen in FIGS. 8 and 2, the body of the housing 180 consists of a flat bottom 188, having outside the lower face 181 of the housing 180, and an upper shell 189 mounted on the flat bottom 188. In this way, it is not possible to remove the housing 180, in particular when a luggage item 700 is mounted on the housing 180.

The upper shell 189 is equipped with openings allowing poles 190, or spacer poles 190 to pass through, the latter acting as spacers. The poles 190 serve to mount the upper plate 186, for example by screwing in the poles 190. When a luggage item is mounted on the upper plate 186, the poles 190 are covered by the luggage item and the screws mounting the upper plate 186 on the poles 190 are not accessible. This prevents the theft of the housing 180, but also the luggage which is firmly mounted on the upper plate 186. The lower plate 183 and the flat bottom 188 are also mounted on the poles 190, in particular by screwing. In this way, the luggage item does not rest directly on the upper shell 189 of the housing 180, but directly on the lower plate 183, mounted on the flat bottom 188. In other words, the upper plate 186 and the lower plate 183 are connected directly via poles 190, the housing body composed of the flat bottom 188 and the upper shell 189 being mounted between the plates. This has the effect of improving the strength of the module 100. This also allows a fresh air inflow to the radiator 150, as explained hereinafter.

It may be envisaged to mount the lower plate 183 on the flat bottom 188 without mounting the poles 190 at the same time. In such a configuration, it is not possible to mount an upper plate 186. This configuration is therefore particularly adapted to the case where no luggage item is to be transported, the size of the housing 180 being reduced and the aesthetic appearance enhanced.

In particular, the upper plate 186 is separated from an upper wall of the body of the housing 180. In other words, the poles 190 protrude sufficiently from the body of the housing 180 to leave a gap between the upper part of the body of the housing 180 and the upper plate 186. Thus, a fresh air inflow entering the housing 180 to the radiator 150 is created, in particular under the action of fans 160 when the module is equipped with them.

The lower face 181 and the upper face 184 of the housing 180 are separated by a distance h, corresponding to the height, or thickness, of the housing 180, and which is substantially constant across the entire width of the housing 180. In other words, the distance h corresponds substantially to the distance between the planes wherein the anchor points 182 and mounting points 185 are located, presented on plates or not.

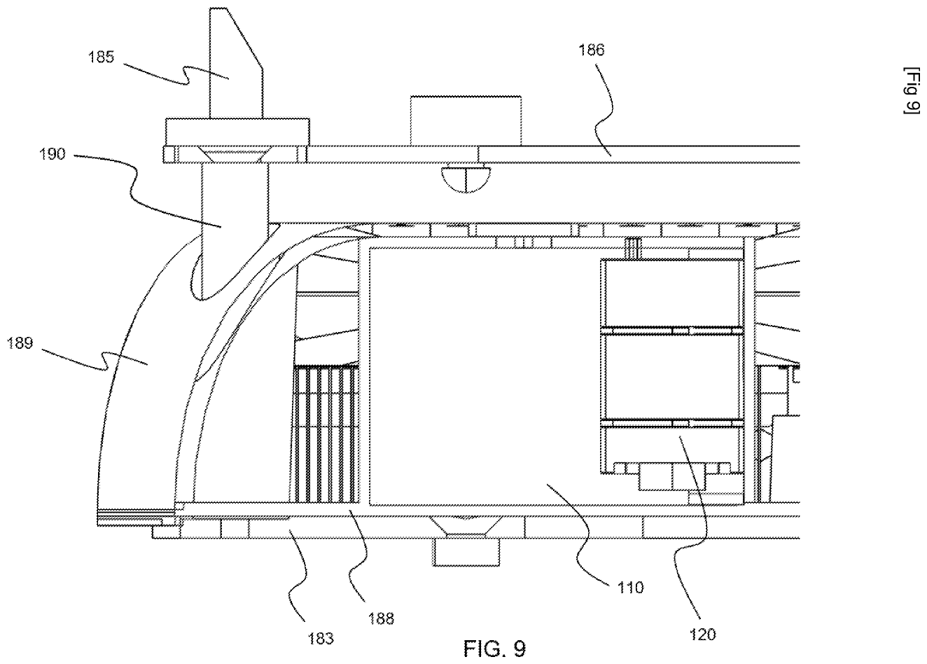

In order to reduce the height h even further, the reservoir 110 may be directly integrated in the lower wall of the housing 180, as represented in FIG. 9. In particular when the flat bottom 188 is moulded (the upper shell 189 being generally also moulded), the reservoir 110 may be directly moulded with the flat bottom. The lower wall of the reservoir 110 is therefore directly formed by the flat bottom 188. This makes it possible to avoid mounting the reservoir 110 on the flat bottom, and makes it possible in particular to reduce the height h further, doing without a lower wall of the reservoir 110.

A housing 180 as described makes it possible to obtain a particularly compact module 100, and in particular which minimises the height h, which is integrated perfectly on a motorcycle, and which is adapted readily to standardised elements.

However, a compact design of the module 100 alone does not make it possible to guarantee suitable operation.

In order to guarantee suitable operation of the module 100, in particular with regard to thermal dissipation, and more broadly heat exchange with the surrounding area, while helping obtain a housing of reduced height h, a certain number of particularly ingenious and effective arrangements are proposed.

Firstly, the heat exchange element 130 is separated from the walls of the housing 18 thanks to a distancing means. Indeed, it is not desirable to allow a heat transfer from or to the heat exchange element 130 on the side of the wall of the housing 180.

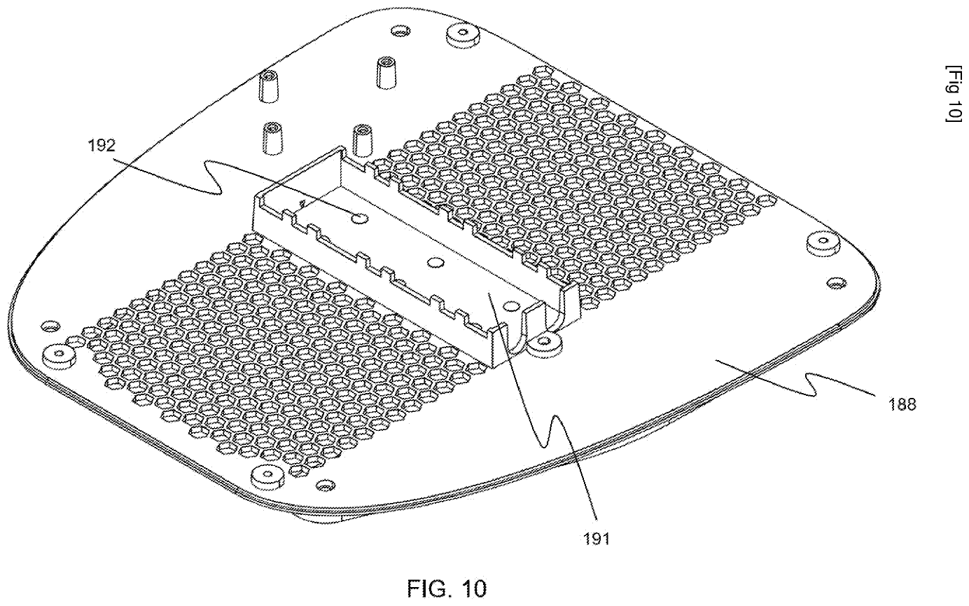

In particular, the heat exchange element 130 is disposed at a location 191 for mounting the heat exchange element 130. The mounting location 191 is preferably located on the flat bottom 188. The mounting location 191 takes for example the form of a zone delimited by a peripheral wall protruding from the flat bottom 188, shaped to the heat exchange element 130 so as to hold it is place laterally, as represented in FIG. 10. The peripheral wall may in particular be directly moulded on the flat bottom 188.

The location 191 for mounting the heat exchange element has a means 192 for distancing the heat exchange element 130 from the walls of the housing 180. In particular, the distancing means 192 may be formed by a plurality of blocks. The blocks may be distributed on the flat bottom 188 in the zone of the mounting location 191, so as to support the heat exchange element 130 suitably. Preferably, the number of blocks is between four and eight, for example six. The blocks are advantageously particularly flat, i.e. they extend from the flat bottom 188 along a height less than 0.5 millimetres. Thus, the height h of the housing remains as small as possible, while holding the heat exchange element 130 slightly away from the walls of the housing 180. Thus, an insulating air layer may be formed between the heat exchange element and the walls of the housing. This has the effect of breaking the thermal bridge that would be formed if the heat exchange element 130 was mounted directly against the walls of the housing 180.

According to an alternative, a strip of insulating material, for example foam, may be used as distancing means 192 instead of the blocks. It is however preferred to use blocks which may in particular be moulded directly with the flat bottom 188, which has the effect of reducing the number of steps of manufacture.

Another particularly effective arrangement is the use of a “heat-pipe” type radiator. More specifically, the second heat exchange face 142 with the surrounding area of the thermoelectric device 140 is thermally connected with at least one “heat-pipe” type radiator 150.

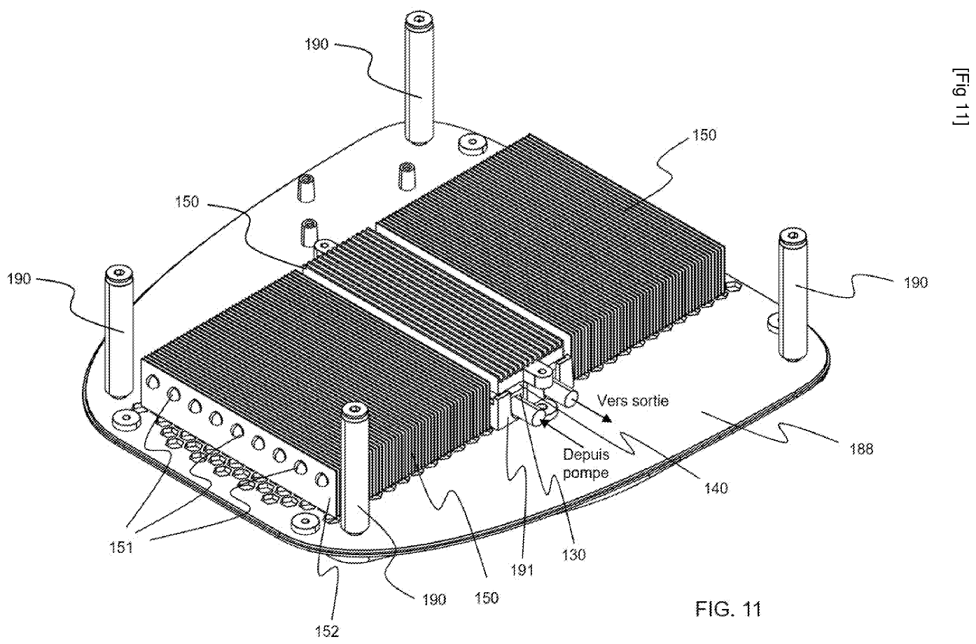

As represented in FIG. 11, the radiator 150 extends in a direction orthogonal to the height h.

The heat-pipe type of radiator 150 is known per se from the prior art. It is composed in particular of one or more parallel longitudinal tubes 151, wherein a fluid in a liquid-vapour equilibrium state is contained. The heat is transferred from the hot source to the cold source by changing state, in particular by condensation. This type of radiator makes it possible to achieve much more substantial heat transfers than using the simple conduction principle of a conventional radiator.

A plurality of ribs 152 orthogonal to the tubes connects the tubes 151, and makes it possible to transfer heat. The radiator 150 represented in FIG. 11 comprises several tens of fins, thus having a large heat exchange surface area. For example, a heat exchange surface area between 0.5 and 2 square metres may be obtained.

The very high efficiency induced by the use of this particular type of radiators is increased further by the widthwise arrangement of the housing 180, and along the direction orthogonal to the height h. A large heat transfer surface area is obtained, without increasing the height h but while benefiting from a very high-performance heat exchange.

This effect is increased further by centring the location 191 for mounting the heat exchange element 130 on the lower wall of the housing, i.e. in particular on the flat bottom 188. The radiator 150 then extends on either side of said location 191, substantially to the lateral walls of the housing 180. The substantially central position makes it possible to maximise the heat exchange by placing the hot source at the centre, and by positioning the ends of the radiators 150, i.e. the cold sources, at the maximum distance from the hot source.

It is therefore understood that the central portion of the radiator 150 represented in FIG. 11, of reduced height, is thermally connected to the Peltier device 140. At this location, the heat exchange element 130, the Peltier device 140 and the radiator 150 are stacked, and form a similar structure to that represented schematically in FIG. 1. On either side of the central position, the radiator 150 occupies the entire height of the stack, so as to maximise the heat exchange surfaces areas.

The height h thus extremely reduced may be reduced further by selecting fans 160 of reduced thickness with respect to a standard fan usually used for modules 100. The use of such particularly flat fans is only possible on account of the very substantial performance of the heat dissipation system proposed, because it is thus possible to do without higher-speed fans.

In order to allow a simplified assembly, the fan(s) 160 may be simply fixed in fingers protruding from the upper shell 189. Stacking the components between the flat bottom 188 and the upper shell 189 indeed provides a sufficient hold in the direction of the thickness of the housing 180 without requiring an additional mounting.

Moreover, perforations may be made in the flat bottom 188 and the upper shell 189 in order to promote the inflow and outflow of fresh air in the housing, allowing better heat transfer.

With all of these arrangements, it is understood that the height h of the housing 180 is minimised and that exchange of heat with the surrounding area is maximised. A housing 180 meeting all the expectations in respect of integration on a motorcycle, as well as the expectations in respect of performance despite the compact nature of the module 100.

It is specified that the housing 180 may also be disposed laterally on a structural element of a motorcycle, in particular to be “sandwiched” between a lateral bracket and a side saddlebag for a motorcycle. In this case, the height h of the housing extends substantially horizontally, perpendicularly to the direction of advance of the motorcycle. The lower 181 and upper 184 faces are therefore laterally oriented, respectively inwards and outwards in respect of the motorcycle. It is understood that the terms lower and upper used in the present description are considered in the reference frame of the housing 180, wherein the lower and upper face are separated by the height h, or thickness, of the housing. In the figures, the lower and upper faces are disposed on top of one another along a direction substantially orthogonal to the ground on which the motorcycle is moving, however in other uses, the upper and lower faces may be disposed on top of one another along a different direction, in particular substantially parallel with the ground on which the motorcycle is moving.

### Other Advantages and Optional Features

Further optional features, not shown in the figures, may also be envisaged. These features may in particular be combined according to any possible combinations.

As indicated above, the connection between the module 100 and the item of clothing 200 may be made indirectly by means of connection conduit, for example a flexible conduit. This is particularly the case when the module 100 and the item of clothing 200 each have a coupling. It is also possible that the conduit leading from the module 100 be extended directly by a conduit, in particular a flexible conduit, and that a single coupling is present on the item of clothing 200.

In both cases, it is advantageous to be able to store the conduit connecting the module 100 and the item of clothing 200.

Thus, it is possible to provide a hatch on one of the lateral walls of the housing 180, accessible from the exterior of the housing, and opening onto a cavity adapted to contain a conduit, in particular a flexible conduit, in a storage position.

The cavity may be produced in a similar manner to the reservoir 110, and the hatch may for example be arranged pivotally on the housing.

In this way, the user may store the conduit for connecting to the item of thermal control clothing when they leave their vehicle, without being hindered by the presence of the conduit. The conduit is moreover disposed protected from damage. The hatch may in particular be locked by a suitable means, such as a lock.

In order to simplify the storage of the conduit, in particular when it is flexible and capable of being wound, it is possible to provide an automatic reel. An automatic reel is presented in the form of a spool on which the conduit can be wound, and which is caused to rotate in a winding direction under the effect, for example, of a spring. Thus, the conduit tends to be driven in the winding position. In order to hold the flexible conduit for connecting to the item of thermal control clothing in the use position, a means for locking the flexible conduit in a variable unwound position is provided. This means may in particular lock the conduit directly so as to prevent its winding, for example by pinching it slightly, or locking the reel directly, for example using a position brake.

Moreover, in a case where the connection conduit would not be entirely stored in the housing 180 in a storage position, it is possible to provide a magnetised zone on one of the lateral walls of the housing 180. In cooperation with an end of the connection conduit that is also magnetised, or metallic, it is possible to hold the end of the conduit in position against the housing 180. This makes it possible on one hand to guarantee suitable storage of the conduit, while allowing a user to take hold of it quickly and simply, when they wish to connect the conduit to the clothing 200.

Another particularly important aspect of a thermal control system is its electrical consumption. Indeed, the module 100 is electrically connected in particular to a motorcycle battery 400, and the latter has a limited capacity. As a general rule, any use of the battery 400 when the motorcycle engine is switched off gives rise to a rapid decrease in its charge level, the latter not generally being provided to run external devices. This aspect is less critical in respect of electric motorcycles, which generally have a battery of larger capacity.

In order to remedy the problem of excessive strain on the battery 400 when an internal combustion powered motorcycle engine is switched off, it is provided to limit the running of the module 100 to periods when the engine is switched on.

For this, the control unit 170 is configured to detect a background noise of the electronic signal from the direct current source, i.e. in particular the battery 400. Background noise means fluctuations in the electric current from the battery, which convey the presence of consumers or producers connected to the battery 400. Such a background noise is particularly substantial when the engine alternator runs and supplies the battery 400, i.e. when the internal combustion engine is operating.

When no background noise is detected, the unit is configured to switch off the module 100. Indeed, such a situation conveys the fact that the engine is no longer running, and that the battery 400 is at a high risk of discharging rapidly.

Finally, an important aspect relates to the item of thermal control clothing 200 per se. Indeed, known temperature regulating clothing is not very visually appealing, and only has comfort, but not safety, properties.

In order to remedy the first drawback, the item of thermal control clothing 200 may be designed according to a double skin structure. The item of clothing 200 then includes a double skin preferably closed by stitching, or by welding, at the periphery of the item of clothing 200. The conduit passing through the item of thermal control clothing 200 is then bonded to the inner skin of the double skin, i.e. on the side of the person wearing the clothing. The conduit is bonded to the inner skin of the inside of the double skin. In this way, the outer skin does not take the shape of the conduit passing through the item of clothing 200, as may be the case in the prior art. The finish is much more aesthetically pleasing, the outer skin being free in relation to the inner skin and has a smoother and more natural appearance.

In order to remedy the second drawback, the item of clothing 200, the item of thermal control clothing 200 is also an item of safety clothing. More specifically, the item of clothing 200 also has an airbag function aimed at protecting the wearer in the event of a fall. For this, the item of clothing 200 includes an airbag. The conduit of the item of thermal control clothing 200 is welded, preferably by high-frequency welding, on an inner face of the airbag. When the airbag function is not used, practically nothing distinguishes the item of control and safety clothing 200 from an item of simple control clothing. Surprisingly, it was observed that combining the control and safety functions was possible without degrading either of the functions, and without the appearance and comfort of the item of clothing 200 being degraded.

What is claimed is:

1. A thermal control module for a system for thermally controlling all or a portion of a person's, in particular a motorcyclist's, body, including an open fluidic circuit comprising:
a compensation reservoir adapted to contain a volume of heat transfer fluid,
a pump adapted to circulate said heat transfer fluid in said open fluidic circuit,
a heat exchange element adapted for the circulation of said heat transfer fluid, said heat exchange element being thermally connected to a first heat exchange face of a Peltier-effect thermoelectric device adapted to be electrically connected to a direct current source, the thermoelectric device having a second heat exchange face with the surrounding area,
characterised in that
said reservoir, said pump and said heat exchange element being fluidically connected and being disposed in the body of a housing, and said open fluidic circuit having an inlet opening and an outlet opening evacuating respectively from said housing, the inlet and outlet openings being adapted to be connected, directly or indirectly via a flexible conduit, respectively to an end of a conduit of an item of thermal control clothing so as to form a closed fluidic circuit,
said housing comprises a lower face having a plurality of anchor points on a structural element of a motorcycle, in particular on a bracket for mounting a “top-case” or saddlebag type luggage item for a motorcycle, and an upper face having a plurality of points for mounting a “top-case” or saddlebag type luggage item for a motorcycle, said lower and upper faces being separated by a height,
said housing has a location for mounting the heat exchange element having a means for distancing the heat exchange element from the walls of the housing,
said heat exchange face with the surrounding area is thermally connected to at least one “heat-pipe” type radiator extending in a direction orthogonal to the height.

2. The module, wherein the anchor points are presented on a lower plate mounted removably on the body of the housing.

3. The module as claimed in claim 1, wherein the mounting points are presented on an upper plate mounted removably on the body of the housing.

4. The module as claimed in claim 1, wherein the anchor points are disposed according to an anchoring pattern reproduced at at least two separate positions, so as to allow the mounting in at least two mounting positions of the housing on said structural element.

5. The module as claimed in claim 1, wherein said distancing means is formed by a plurality of blocks moulded on a lower wall of the body of the housing, the blocks being adapted to support said heat exchange element.

6. The module as claimed in claim 1, wherein said distancing means is a layer of insulating material disposed against a lower wall of the body of the housing.

7. The module as claimed in claim 1, wherein the location for mounting the heat exchange element is substantially centred on a lower wall of the body of the housing, and wherein said radiator extends at least on either side of said location, substantially to the lateral walls of said body of the housing.

8. The module as claimed in claim 1, wherein said reservoir is directly integrated in the lower wall of said housing body.

9. The module as claimed in claim 1, wherein the housing body comprises a magnetised zone on one of its lateral walls.

10. The module as claimed in claim 1, wherein the housing comprises a hatch on one of its lateral walls, accessible from the exterior of the housing, opening onto a cavity adapted to contain a flexible conduit for connecting to an item of thermal control clothing in a storage position.

11. The module as claimed in claim 1, wherein the housing comprises an automatic reel, preferably with a spring, of a flexible conduit for connecting to an item of thermal control clothing, and a means for locking said flexible conduit in a variable unwound position.

12. The module as claimed in claim 1, wherein the module also comprises a control unit connected to said thermoelectric device and to said pump, and configured at least to switch said module on and off, and control an operating temperature or control a power consumption by the thermoelectric device.

13. The module according to claim 12, wherein the control unit comprises a means for wireless communication with a remote control of said module, said remote control being configured at least to switch said module on and off, and set a set-point temperature of the person's body or control a power consumption level by the thermoelectric device.

14. The module as claimed in claim 12, wherein the control unit is configured to
detect a background noise of the electronic signal from the direct current source, wherein the direct current source is a battery external to said module, in particular a motorcycle battery;
and when no background noise is detected;
switching the module off.

15. A system for thermally controlling all or a portion of a person's, in particular a motorcyclist's, body, comprising a thermal control module as claimed in claim 1, and an item of thermal control clothing, the inlet and outlet options of said module being connected, directly or indirectly via a flexible conduit, respectively to an end of a conduit of the item of thermal control clothing.

16. The system according to claim 15, wherein the item of thermal control clothing includes a double skin closed by stitching at the periphery of the item of clothing, and wherein the conduit of the thermal control clothing is bonded to the inner skin of the double skin, so as to be located inside the double skin.

17. The system according to claim 15, wherein the item of thermal control clothing is also an item of safety clothing and includes an airbag, the conduit of the item of thermal control clothing being welded, preferably by high-frequency welding, on an inner face of said airbag.

18. An assembly comprising a motorcycle and a system for thermally controlling all or a portion of a person's, in particular a motorcyclist's, body as claimed in claim 15, and wherein said module is electrically connected to a motorcycle battery, and mechanically connected to a structural element of the motorcycle, in particular to a bracket for mounting a “top-case” or saddlebag type luggage item for a motorcycle, via said plurality of anchor points on a structural element of a motorcycle.

19. The assembly according to claim 18, furthermore comprising a “top-case” or saddlebag type luggage item for a motorcycle mounted on said module via said plurality of points for mounting a “top-case” or saddlebag type luggage item for a motorcycle, such that said housing is “sandwiched” between said structural element of the motorcycle and said luggage item for a motorcycle.
